(19) United States
(12) Patent Application Publication
(10) Pub. No.: US 2015/0153663 A1
(43) Pub. Date: Jun. 4, 2015

(54) Hyperpigmented Glossy EA Toner

(71) Applicant: Xerox Corporation, Norwalk, CT (US)

(72) Inventors: Abdisamed Sheik-Qasim, Etobicoke (CA); Richard PN Veregin, Mississauga (CA); Mark R Elliott, Burlington (CA); Melanie L Davis, Hamilton (CA); Shigang Qiu, Toronto (CA); Jay L Schneider, Canadaigua, NY (US); Randy P Tin, Webster, NY (US); Magid Kamel, North York (CA); Cuong Vong, Hamilton (CA); Edward G Zwartz, Mississauga (CA)

(73) Assignee: Xerox Corporation, Norwalk, CT (US)

(21) Appl. No.: 14/093,860

(22) Filed: Dec. 2, 2013

(51) Int. Cl. G03G 9/08

(52) U.S. Cl. CPC G03G 9/0804

(57) ABSTRACT

An emulsion aggregation toner process that does not require addition of base to freeze toner particle growth is described.

### FIELD

An improved process for making emulsion aggregation (EA) toner particles with faster aggregation and coalescence, higher pigment loading and lower metal cation levels enables images with lower TMA and tunable gloss.

### BACKGROUND

Emulsion aggregation (EA) toner particles may comprise polyester resins, which are aggregated to form structures of a desired shape and size, followed by the coalescence of the aggregated particles, for example, at an elevated temperature. The components incorporated into the toner shape the characteristics of the final toner particles. For example, a colorant may be added, a wax may be added to provide release from a fuser roll, and a particular binder resin may be added to provide a low minimum fusing temperature (MFT). Another toner property which may be controlled by the components of the EA toner particles is fused image gloss. Examples of teachings of materials and methods for making EA toner include U.S. Pat. Nos. 5,290,654; 5,344,738; 5,346,797; 5,496,676; 5,501,935; 5,747,215; 5,840,462; 5,869,215; 6,828,073; 6,890,696; 6,936,396; 7,037,633; 7,049,042; 7,160,661; 7,179,575; 7,186,494; 7,217,484; 7,767,376; 7,829,253; 7,858,285; and 7,862,971, the disclosure of each hereby is incorporated by reference in entirety.

Toners with higher pigment loadings, such as required for high-yield (HY) (or hyperpigmented) toners or smaller sized toners, such as those less than 4 μm in size, can have long aggregation times. One solution is to reduce the solids loading, which reduces aggregation time, but at the expense of yield and process cost. A second solution is to increase freeze temperature, which reduces aggregation time, but results in higher residual metal ion levels, as the increased aggregation temperature traps greater amounts of metal ion in and on the toner particle, resulting in uncontrollable or lower gloss. However, at higher pigment loadings, increasing freeze temperature is not sufficient to provide both a reasonable aggregation time and lower metal ion content at the prevailing solids loading amount in commercial toners.

Many emulsion aggregation processes use sodium hydroxide solution and optionally smaller amounts of EDTA to increase pH to freeze aggregation. With higher residual metal cation in the toner particle, gloss is lowered. That relationship is relevant in uses with lower toner mass per unit area (TMA) applications, such as, hyperpigmented toner and smaller sized toner, since lower TMA also reduces gloss.

It is desirable to improve the EA toner process to obtain toner with higher pigment loading without losing control of image gloss.

### SUMMARY

The instant disclosure provides a polyester resin prepared by a method that freezes particle aggregation solely through the use of a chelating agent. No other reagents are used to stop particle growth. That process enables aggregation, freeze and coalescence to occur at higher temperatures, thereby reducing aggregation and coalescence times. The higher amounts of chelating agent reduce residual cation amount thereby increasing gloss. The resulting toner provides images at lower TMA with tunable or adequate gloss. Hence, a method of interest for making a high gloss toner particle in the absence of base or a basic buffer in the aggregation freezing step to terminate particle growth comprises mixing reagents comprising one or more amorphous resins, an optional crystalline resin, an optional wax, an optional colorant and an optional gel latex to form an emulsion comprising a resin particle; adding a flocculant and aggregating said resin particle to form a nascent toner particle; optionally adding one or more resins to form a shell on said nascent toner particles to yield a core-shell particle; freezing particle growth exclusively with a chelating agent in the absence of base or a basic buffer to form an aggregated toner particle; optionally coalescing said aggregated toner particle to form said high gloss toner particle; and collecting said high gloss toner particle.

### DETAILED DESCRIPTION

### I. Introduction

Standard processes for preparing EA toner particles often use base, such as, sodium hydroxide or a higher pH buffer, and optionally a small amount of EDTA, for example, about 5% by weight of dry toner, to halt particle aggregation to freeze particle growth.

Toners with higher pigment loadings, such as, high-yield toner or smaller sized toner particles, can have longer aggregation times. One current solution is to reduce the solids loading, which reduces aggregation time. However, yields decrease thereby increasing overall cost.

A second solution is to increase freeze temperature, which results in higher residual metal ion levels, as the increased aggregation temperature traps the metal ions in and on the toner particle. However, at higher pigment loadings, increasing the freeze temperature per se is insufficient to provide both a reasonable aggregation time and lower metal cation levels at the current solids loading, and as scale increases, the higher freeze temperature will stress aggregation time as well.

Increasing chelator, such as, EDTA, with current processes is not an option. In general, increasing reagents and reagent amounts in the emulsion can have a detrimental effect, those reagents can find their way into or onto the toner particle, which could have a negative impact on toner performance.

The present disclosure provides a method that completely eliminates the addition of base, such as, sodium hydroxide, to raise the slurry pH to freeze particle growth. Instead, larger amounts of a chelating agent, such as, from about 7% to about 35%, from about 8.5% to about 25%, from about 10% to about 20%, for example, a chelator, such as, EDTA, are added to the slurry to, for example, increase pH, surprisingly, completely replacing base to raise pH, and freezing particle growth. The chelating agent has the dual role of increasing and controlling the pH and of extracting metals ions, such as, Al ions. As a result, the temperature during aggregation and freeze can be increased while robustly maintaining a lower residual metal ion content. Aggregation occurs faster and lower metal ion content is found in the toner, enabling hyperpigmented toner, reduced TMA and required gloss. Most chelating agents are commercially available and inexpensive. The resulting toner is more robust with respect to controlling and maintaining lower metal ion levels. The resulting toner also comprises higher levels of chelator that does toner made using base and chelator to freeze aggregation (normal toner). Thus, toners of interest comprise at least about 5% more chelator than normal toner, at least about 10% more chelator than normal toner, at least about 15% more chelator than normal toner.

A toner of interest comprises higher levels of chelating agent than found in toner made where aggregation is not frozen using chelating agent alone. Normally, toner can comprise about 2000 ppm sodium ion, which is obtained from NaOH and sodium EDTA which are normally used to freeze aggregation. On the other hand, a toner of interest, where aggregation is frozen without use of base, can have a chelating agent content, as inferred from sodium ion content, of more than 2000 ppm, more than about 2100 ppm, more than about 2200 ppm, or more. As the only source of sodium ion in a toner of interest arises from, for example, sodium EDTA alone as no base, such as NaOH is used, a measure of sodium levels is a measure of chelating agent levels in toner.

In a typical EA high-yield toner process, use of a coagulant and after shell addition, the reaction is heated to no higher than about 47 to 48° C. because higher temperatures, the level of metal ion, such as, aluminum ion, increases. When the growing, nascent toner particle size reaches the desired size, freezing begins with the pH of the slurry being adjusted to about 4.5 using a 4% sodium hydroxide (NaOH) solution. That is then followed by the addition of about 5% by weight of dry toner, EDTA (such as, Versene 100), which is an EDTA solution), and more NaOH solution until the pH reaches 7.8. The temperature then is ramped to coalescence while maintaining the pH to 7.8.

In the process of interest, after use of a coagulant and after shell addition, the reaction is heated to a higher temperatures, for example, at least 50° C., such as, from about 50° C. to about 55° C. to enable faster aggregation. When the toner particle size reaches the desired size, freezing begins with the pH of the slurry being adjusted to 7.8 using just a chelating agent, such as, chelator, such as, EDTA (such as, Versene 10)) without the need for a base or a basic buffer. The temperature then is ramped to coalescence while maintaining the pH at 7.8 using the chelating agent alone.

The freeze temperature may be about 50° C. or greater, about 52° C. or greater, about 53° C. or greater, about 54° C. or greater, about 55° C. or greater, about 56° C. or greater, or higher.

Unless otherwise indicated, all numbers expressing quantities and conditions, and so forth used in the specification and claims are to be understood as being modified in all instances by the term, “about.” “About,” is meant to indicate a variation of no more than 10% from the stated value. Also used herein is the term, “equivalent,” “similar,” “essentially,” “substantially,” “approximating,” and “matching,” or grammatical variations thereof, have generally acceptable definitions or at the least, are understood to have the same meaning as, “about.”

A, “polyacid,” is a monomer for forming a polyester polymer for toner that comprises at last two reactive acidic groups, such as, a carboxylic acid group, at least three acidic groups or more. Hence, a diacid, a triacid and so on are encompassed by a polyacid.

A, “polyol,” is a monomer for forming a polyester polymer for toner that comprises at least two reactive hydroxyl groups, such as, an alcohol, at least three hydroxyl groups or more. Hence, a dialcohol or diol, a trialcohol or triol and so on are encompassed by a polyol.

While a reacted monomer per se is not present in a polymer, for the purposes herein, a polymer is defined by the component monomers used to make that polymer. Hence, for a polyester made from a polyol and a polyacid, which during the condensation reaction loses a water molecule for each ester bond, the polymer is said to comprise said polyol and said polyacid. Thus, for example, if 1,2-propanediol and trimellitic acid are reacted to form a polyester, even though technically 1,2-propanediol and trimellitic acid no longer are present in the polyester polymer, herein, the polymer is said to comprise 1,2-propanediol and trimellitic acid.

### II. Toner Particles

The Loner particle includes one or more resins, and may include other optional reagents, such as, a surfactant, a wax, a shell and so on. The toner composition optionally may comprise inert particles, which may serve as toner particle carriers, which may comprise the resin taught herein. The inert particles may be modified, for example, to serve a particular function. Hence, the surface thereof may be derivatized or the particles may be manufactured for a desired purpose, for example, to carry a charge or to possess a magnetic field.

A. Components

1. Resin

Toner particles of the instant disclosure may comprise any known resin as known in the art as suitable therefor. The discussion below focuses on polyester polymers.

In embodiments, bifunctional reagents, trifunctional reagents and so on may be used. One or more reagents that comprise at least three functional groups can be incorporated into a polymer or into a branch to enable branching, further branching and/or crosslinking. Examples of such polyfunctional monomers for a polyester include 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane and 1,2,7,8-octanetetracarboxylic acid, acid anhydrides thereof, lower alkyl esters thereof and so on. The branching agent may be used in an amount from about 0.01 to about 10 mole %, from about 0.05 to about 8 mole %, from about 0.1 to about 5 mole %. Polyester resins, for example, may be used for applications requiring low melting temperature.

One, two or more polymers may be used in forming a toner or toner particle. In embodiments where two or more polymers are used, the polymers may be in any suitable ratio (e.g., weight ratio) such as, for instance, with two different polymers, from about 1% (first polymer)/99% (second polymer) to about 99% (first polymer)/1% (second polymer), from about 10% (first polymer)/90% (second polymer) to about 90% (first polymer)/10% (second polymer) and so on, as a design choice.

The polymer may be present in an amount of from about 65 to about 95% by weight, from about 75 to about 85% by weight of toner particles on a solids basis.

a. Polyester Resins

Suitable polyester resins include, for example, those which are sulfonated, non-sulfonated, crystalline, amorphous, combinations thereof and the like. The polyester resins may be linear, branched, crosslinked, combinations thereof and the like. Polyester resins may include those described, for example, in U.S. Pat. Nos. 6,593,049; 6,830,860; 7,754,406; 7,781,138; 7,749,672; and 6,756,176, the disclosure of each of which hereby is incorporated by reference in entirety.

When a mixture is used, such as, amorphous and crystalline polyester resins, the ratio of crystalline polyester resin to amorphous polyester resin may be in the range from about 1:99 to about 30:70; from about 5:95 to about 25:75; from about 5:95 to about 15:95.

A polyester resin may be obtained synthetically, for example, in an esterification reaction involving a reagent comprising polyacid groups and another reagent comprising a polyol. In embodiments, the alcohol reagent comprises three or more hydroxyl groups, in embodiments, four or more hydroxyl groups, or more. In embodiments, the polyacid comprises three or more carboxylic acid groups, in embodiments, four or more carboxylic acid groups, or more. Reagents comprising three or more functional groups enable, promote or enable and promote polymer branching and crosslinking. In embodiments, a polymer backbone or a polymer branch comprises at least one monomer unit comprising at least one pendant group or side group, that is, the monomer reactant from which the unit was obtained comprises at least three functional groups.

Examples of polyols which may be used in generating an amorphous polyester resin include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, 1,4-cyclohexanedimethanol, 1,3-cyclohexanedimethanol xylenedimethanol, cyclohexanediol, diethylene glycol, bis(2-hydroxyethyl) oxide, dipropylene glycol, dibutylene glycol, and combinations thereof. The amount of polyol may vary, and may be present, for example, in an amount from about 40 to about 60 mole % of the resin, from about 42 to about 55 mole % of the resin, from about 45 to about 53 mole % of the resin.

Examples of polyacids or polyesters that can be used include terephthalic acid, phthalic acid, isophthalic acid, fumaric acid, trimellitic acid, diethyl fumarate, dimethyl itaconate, cis-1,4-diacetoxy-2-butene, dimethyl fumarate, diethyl maleate, maleic acid, succinic acid, itaconic acid, succinic acid, cyclohexanoic acid, succinic anhydride, dodecylsuccinic acid, dodecylsuccinic anhydride, glutaric acid, glutaric anhydride, adipic acid, pimelic acid, suberic acid, azelaic acid, dodecanedioic acid, dimethyl naphthalenedicarboxylate, dimethyl terephthalate, diethyl terephthalate, dimethylisophthalate, diethylisophthalate, dimethylphthalate, phthalic anhydride, diethylphthalate, dimethylsuccinate, naphthalene dicarboxylic acid, dimer diacid, dimethylfumarate, dimethylmaleate, dimethylglutarate, dimethyladipate, dimethyl dodecylsuccinate and combinations thereof.

Examples of amorphous resins which may be used include alkali sulfonated-polyester resins, branched alkali sulfonated-polyester resins, alkali sulfonated-polyimide resins and branched alkali sulfonated-polyimide resins. Alkali sulfonated polyester resins may be useful in embodiments, such as, the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate) and copoly(propylene-butylene-terephthalate)-copoly(propylene-butylene-5-sulfo-isophthalate), wherein the alkali metal is, for example, a sodium, a lithium or a potassium ion.

In embodiments, an unsaturated amorphous polyester resin may be used as a latex resin. Examples of such resins include those disclosed in U.S. Pat. No. 6,063,827, the disclosure of which hereby is incorporated by reference in entirety. Exemplary unsaturated amorphous polyester resins include, but are not limited to, poly(1,2-propylene fumarate), poly(1,2-propylene itaconate) and combinations thereof.

For forming a crystalline polyester resin, suitable polyols include aliphatic polyols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-,1,3-propanediol, lithio 2-sulfo-1,3-propanediol, potassio 2-sulfo-1,3-propanediol, mixtures thereof and the like, including structural isomers thereof.

Examples of polyacid or polyester reagents for preparing a crystalline resin include oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, mesaconic acid, a polyester or anhydride thereof, an alkali sulfo-organic polyacid, such as, the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfo-p-hydroxybenzoic acid. N,N-bis(2-hydroxyethyl)-2-amino ethane sulfonate, or mixtures thereof. The polyacid may be selected in an amount of, for example, in embodiments, from about 40 to about 60 mole %, from about 42 to about 52 mole %, from about 45 to about 50 mole %. Optionally, a second polyacid may be selected in an amount from about 0.1 to about 10 mole % of the resin.

Specific crystalline resins include poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipatenonylene-decanoate), poly(octylene-adipate), and so on, wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide) and poly(butylene-succinimide).

Suitable crystalline resins which may be utilized, optionally in combination with an amorphous resin as described above, include those disclosed in U.S. Pub. No. 2006/0222991, the disclosure is incorporated by reference in entirety.

A suitable crystalline resin may include a resin formed of ethylene glycol and a mixture of dodecanedioic acid and fumaric acid comonomers.

Examples of other suitable resins or polymers which may be utilized in forming a toner include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and combinations thereof. The polymer may be, for example, block, random or alternating copolymers.

The crystalline resin may be present, for example, in an amount from about 1 to about 85% by weight of the toner components, in embodiments, from about 2 to about 50% by weight of the toner components, from about 5 to about 15% by weight of the toner components. The crystalline resin may possess various melting points of, for example, from about 30° C. to about 120° C. from about 50° C. to about 90° C., from about 60° C. to about 80° C. The crystalline resin may have a number average molecular weight (Mₙ), as measured by gel permeation chromatography (GPC) of, for example, from about 1,000 to about 50,000, from about 2,000 to about 25,000; and a weight average molecular weight (M_{w}) of from about 2,000 to about 100,000, from about 3,000 to about 80,000, as determined by GPC. The molecular weight distribution (M_{w}/Mₙ) of the crystalline resin may be, for example, from about 2 to about 6, from about 3 to about 4.

b. Catalyst

Condensation catalysts may be used to facilitate the condensation reaction and when present, can include tetraalkyl titanates; dialkyltin oxides, such as, dibutyltin oxide; tetraalkyltins, such as, dibutyltin dilaurate; dibutyltin diacetate; dialkyltin oxide hydroxides, such as, butyltin oxide hydroxide; aluminum alkoxides, alkyl zinc, dialkyl zinc, zinc oxide, stannous oxide, stannous chloride or combinations thereof. In embodiments, such catalysts may include butylstannoic acid (Fascat 4100®) and dibutyltin oxide (Fascat 4201®), Arkema Inc., Philadelphia, Pa.

Such catalysts may be used in amounts of, for example, from about 0.01 mole % to about 5 mole % based on the amount of starting polyacid, polyol or polyester reagent in the reaction mixture.

c. Initiator

In embodiments, the resin may be a crosslinkable resin. A crosslinkable resin is a resin, for example, including a crosslinkable group or groups such as a C═C bond or a pendant group or side group, such as, a carboxylic acid group. The resin may be crosslinked, for example, through a free radical polymerization with an initiator.

Suitable initiators include peroxides, such as, organic peroxides or azo compounds, for example diacyl peroxides, such as, decanoyl peroxide, lauroyl peroxide and benzoyl peroxide, ketone peroxides, such as, cyclohexanone peroxide and methyl ethyl ketone; alkyl peroxy esters, such as, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate and t-amyl peroxy benzoate; alkyl peroxides, such as, dicumyl peroxide, 2,5-dimethyl 2,5-di(t-butyl peroxy)hexane, t-butyl cumyl peroxide, bis(t-butyl peroxy)diisopropyl benzene, di-t-butyl peroxide and 2,5-dimethyl 2,5-di(t-butyl peroxy)hexyne-3; alkyl hydroperoxides, such as, 2,5-dihydro peroxy 2,5-dimethyl hexane, cumene hydroperoxide, t-butyl hydroperoxide and t-amyl hydroperoxide, and alkyl peroxyketals, such as, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy)butane, ethyl 3,3-di(t-butyl peroxy)butyrate and ethyl 3,3-di(t-amyl peroxy)butyrate; azobis-isobutyronitrile, 2,2′-azobis(isobutyronitrile), 2,2′-azobis(2,4-dimethyl valeronitrile), 2,2′-azobis(methyl butyronitrile), 1,1′-azobis(cyano cyclohexane), 1,1-di(t-butyl peroxy)-3,3,5-trimethylcyclohexane, combinations thereof and the like. The amount of initiator used is proportional to the degree of crosslinking, and thus, the gel content of the polyester material. The amount of initiator used may range from, for example, about 0.01 to about 10 weight %, from about 0.1 to about 5 weight % of the polyester resin. In the crosslinking, it is desirable that substantially all of the initiator be consumed. The crosslinking may be carried out at high temperature and thus, the reaction may be very fast, for example, less than 10 minutes, such as, from about 20 seconds to about 2 minutes residence time.

Generally, as known in the art, the polyacid/polyester and polyol are mixed together, optionally with a catalyst, and incubated optionally at an elevated temperature, such as, from about 180° C. or more, from about 190° C. or more, from about 200° C. or more, and so on, which may be conducted anaerobically, to enable esterification to occur until equilibrium, which generally yields water or an alcohol, such as, methanol, arising from forming the ester bonds in esterification reactions. The reaction may be conducted under vacuum to promote polymerization. The product is collected by practicing known methods, and may be dried, again, by practicing known methods to yield particulates.

Polyester resins suitable for use in an imaging device are those which carry one or more properties, such as, a T_{g}(onset) of from about 90° C. to about 150° C., from about 100° C. to about 140° C., from about 110° C. to about 130° C.; a T_{g} of from about 10° C. to about 120° C., from about 20° C. to about 110° C., from about 30° C. to about 100° C.; an acid value (AV) of from about 2 to about 30, from about 3 to about 25, from about 4 to about 20; an Mn of from about 2000 to about 100,000, from about 3000 to about 90,000, from about 4000 to about 80,000; a PDI from about 2 to about 8, from about 3 to about 7, from about 4 to about 6; and an Mw of at least about 5000, at least about 15,000, at least about 20,000, at least about 100,000.

2. Colorants

Suitable colorants include those comprising carbon black, such as, REGAL 330® and Nipex 35; magnetites, such as, Mobay magnetites, MO8029™ and MO8060™; Columbian magnetites, MAPICO® BLACK; surface-treated magnetites; Pfizer magnetites, CB4799™, CB5300™, CB5600™ and MCX6369™; Bayer magnetites, BAYFERROX 8600™ and 8610™; Northern Pigments magnetites, NP-604™ and NP-608™; Magnox magnetites, TMB-100™ or TMB-104™; and the like.

Colored pigments, such as, cyan, magenta, yellow, red, orange, green, brown, blue or mixtures thereof may be used. The additional pigment or pigments may be used as water-based pigment dispersions.

Examples of pigments include SUNSPERSE 6000, FLEXIVERSE and AQUATONE, water-based pigment dispersions from SUN Chemicals; HELIOGEN BLUE L6900™, D6840™, D7080™, D7020™, PYLAM OIL BLUE™, PYLAM OIL YELLOW™ and PIGMENT BLUE I™ available from Paul Uhlich & Company, Inc.; PIGMENT VIOLET I™, PIGMENT RED 48™, LEMON CHROME YELLOW DCC 1O26™, TOLUIDINE RED™ and BON RED C™ available from Dominion Color Corporation, Ltd., Toronto, Ontario; NOVAPERM YELLOW FGL™ and HOSTAPERM PINK E™ from Hoechst; CINQUASIA MAGENTA™ available from E.I. DuPont de Nemours & Co. and the like.

Examples of magenta pigments include 2,9-dimethyl-substituted quinacridone, an anthraquinone dye identified in the Color Index (CI) as CI 60710. CI Dispersed Red 15, a diazo dye identified in the Color Index as CI 26050, CI Solvent Red 19 and the like.

Illustrative examples of cyan pigments include copper tetra(octadecylsulfonamido) phthalocyanine, a copper phthalocyanine pigment listed in the Color Index as CI 74160, CI Pigment Blue, Pigment Blue 15:3, Pigment Blue 15:4, an Anthrazine Blue identified in the Color Index as CI 69810, Special Blue X-2137 and the like.

Illustrative examples of yellow pigments are diarylide yellow 3,3-dichlorobenzidene acetoacetanilide, a monoazo pigment identified in the Color Index as CI 12700, CI Solvent Yellow 16, a nitrophenyl amine sulfonamide identified in the Color Index as Foron Yellow SE/GLN, CI Disperse Yellow 3,2,5-dimethoxy-4-sulfonanilide phenylazo-4′-chloro-2,5-dimethoxy acetoacetanilide and Permanent Yellow FGL.

Other known colorants may be used, such as, Levanyl Black A-SF (Miles, Bayer) and Sunsperse Carbon Black LHD 9303 (Sun Chemicals), and colored dyes, such as, Neopen Blue (BASF), Sudan Blue OS (BASF), PV Fast Blue B2G 01 (American Hoechst), Sunsperse Blue BHD 6000 (Sun Chemicals), Irgalite Blue BCA (CibaGeigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF). Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), SUCD-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich). Scarlet for Thermoplast NSD PS PA (Ugine Kuhlmann of Canada), E. D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing and the like. Other pigments that may be used, and which are commercially available include various pigments in the color classes, Pigment Yellow 74, Pigment Yellow 14, Pigment Yellow 83, Pigment Orange 34, Pigment Red 238, Pigment Red 122, Pigment Red 48:1, Pigment Red 269, Pigment Red 53:1, Pigment Red 57:1, Pigment Red 83:1, Pigment Violet 23, Pigment Green 7 and so on, and combinations thereof.

The colorant, for example, carbon black, cyan, magenta and/or yellow colorant, may be incorporated in an amount sufficient to impart the desired color to the toner. Pigment or dye, may be employed in an amount ranging up to about 35% by weight of the toner particles on a solids basis, up to about 25%, up to about 15% by weight. A toner of interest can comprise higher levels of colorant than found in conventional loner now in commercial use. Such hyperpigmented toners enable use of lower amounts of toner.

As used herein, “hyperpigmented” means a toner having high pigment loading at low toner mass per unit area (TMA, calculated as known in the art), for example, such toners may have an increased in pigment loading of at least about 25%, at least about 35%, at least about 45%, at least about 55% or more by weight of the toner particle relative to non-hyperpigmented toners (e.g., toners having carbon black pigment loadings of 6% or lower). In embodiments, a hyperpigmented toner as used herein is any new formulation wherein the amount of pigment is at least about 1.2 times that found in a control, non-hyperpigmented or known toner, in embodiments, at least about 1.3 times, at least about 1.4 times, at least about 1.5 times or more pigment as found in a control or known formulation.

In embodiments, “hyperpigment,” and grammatic forms thereof is meant to describe a toner or toner preparation that on printing and fusing the toner particles to the substrate to form an image of a 100% solid area single color patch, the thickness of that image is less than about 50%, less than about 60%, less than about 70% of a diameter of the toner particles, as provided, for example, in U.S. Pub. No. 20110250536.

In embodiments, “hyperpigmented,” means a toner having high pigment loading at low TMA than found in conventional toner, such as to provide a sufficient image reflection optical density (ODr) of greater than 1.40, greater than 1.45, greater than 1.50 when printed and fused on a substrate, such pigment loading chosen so that the ratio of TMA measured for a single color layer in mg/cm² divided by the volume diameter of the toner particle in microns, is less than about 0.075 to meet that required image density. The TMA may be about 0.55 mg²/cm or less, about 0.525 mg²/cm or less, about 0.5 mg²/cm or less or lower.

“Low melt,” relates to toners that have a T_{g} of from about 45° C. to about 85° C., from about 50° C. to about 65° C., from about 50° C. to about 60° C. Low melt also can relate to toners that have a fusing temperature of from about 75° C. to about 150° C., from about 80° C. to about 140° C., from about 90° C. to about 130° C. A low melt toner comprises resins with lower glass or melting temperatures and other reagents, such as, waxes, are selected to have the appropriate melting point.

3. Optional Components

a. Surfactants

In embodiments, toner compositions may be in dispersions including surfactants. Emulsion aggregation methods where the polymer and other components of the toner are in combination may employ one or more surfactants to form an emulsion.

One, two or more surfactants may be used. The surfactants may be selected from ionic surfactants and nonionic surfactants, or combinations thereof. Anionic surfactants and cationic surfactants are encompassed by the term, “ionic surfactants.”

The surfactant(s) may be used in an amount of from about 0.01% to about 5% by weight of the toner-forming composition, from about 0.75% to about 4% by weight of the toner-forming composition, from about 1% to about 3% by weight of the toner-forming composition.

Examples of nonionic surfactants include, for example, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy) ethanol, for example, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC® PR/F, in embodiments, SYNPERONIC® PR/F 108; and a DOWFAX, available from The Dow Chemical Corp.

Anionic surfactants include sulfates and sulfonates, such as, sodium dodecylsulfate (SDS), sodium dodecylbenzene sulfonate, sodium dodecylnaphthalene sulfate and so on; dialkyl benzenealkyl sulfates; acids, such as, palmitic acid, and NEOGEN or NEOGEN SC obtained from Daiichi Kogyo Seiyaku, and so on, combinations thereof and the like. Other suitable anionic surfactants include, in embodiments, alkyldiphenyloxide disulfonates or TAYCA POWER BN2060 from Tayca Corporation (Japan), which is a branched sodium dodecyl benzene sulfonate. Combinations of those surfactants and any of the foregoing nonionic surfactants may be used in embodiments.

Examples of cationic surfactants include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, trimethyl ammonium bromides, halide salts of quarternized polyoxyethylalkylamines, dodecylbenzyl triethyl ammonium chlorides, MIRAPOL® and ALKAQUAT® available from Alkaril Chemical Company, SANISOL® (benzalkonium chloride) available from Kao Chemicals and the like, and mixtures thereof, including, for example, a nonionic surfactant as known in the art or provided hereinabove.

b. Waxes

The toners of the instant disclosure, optionally, may contain a wax, which may be either a single type of wax or a mixture of two or more different types of waxes (hereinafter identified as, “a wax”.) A wax may be added to a toner formulation or to a developer formulation, for example, to improve particular toner properties, such as, toner particle shape, charging, fusing characteristics, gloss, stripping, offset properties and the like. Alternatively, a combination of waxes may be added to provide multiple properties to a toner or a developer composition. A wax may be included as, for example, a fuser roll release agent.

The wax may be combined with the resin-forming composition for forming toner particles. When included, the wax may be present in an amount of, for example, from about 1 wt % to about 25 wt % of the toner particles, from about 5 wt % to about 20 wt % of the toner particles.

Waxes that may be selected include waxes having, for example, an Mw of from about 500 to about 20,000, from about 1,000 to about 10,000. Waxes that may be used include, for example, polyolefins, such as, polyethylene, polypropylene and polybutene waxes, such as, those that are commercially available, for example, POLYWAX™ polyethylene waxes from Baker Petrolite, wax emulsions available from Michaelman, Inc. or Daniels Products Co., EPOLENE N15™ which is commercially available from Eastman Chemical Products, Inc., VISCOL 550-P™, a low weight average molecular weight polypropylene available from Sanyo Kasei K. K.; plant-based waxes, such as carnauba wax, rice wax, candelilla wax, sumac wax and jojoba oil; animal-based waxes, such as beeswax; mineral-based waxes and petroleum-based waxes, such as montan wax, ozokerite, ceresin wax, paraffin wax, microcrystalline wax and Fischer-Tropsch waxes; ester waxes obtained from higher fatty acids and higher alcohols, such as stearyl stearate and behenyl behenate; ester waxes obtained from higher fatty acids and monovalent or multivalent lower alcohols, such as butyl stearate, propyl oleate, glyceride monostearate, glyceride distearate and pentaerythritol tetrabehenate; ester waxes obtained from higher fatty acids and multivalent alcohol multimers, such as diethyleneglycol monostearate, dipropyleneglycol distearate, diglyceryl dislearate and triglyceryl tetrastearate; sorbitan higher fatty acid ester waxes, such as sorbitan monostearate; cholesterol higher fatty acid ester waxes, such as, cholesteryl stearate, and so on.

Examples of functionalized waxes that may be used include, for example, amines and amides, for example, AQUA SUPERSLIP 6550™ and SUPERSLIP 6530™ available from Micro Powder Inc.; fluorinated waxes, for example, POLYFLUO 190™, POLYFLUO 200™, POLYSILK 19™ and POLYSILK 14™ available from Micro Powder Inc.; mixed fluorinated amide waxes, for example, MICROSPERSION 19™ also available from Micro Powder Inc.; imides, esters, quaternary amines, carboxylic acids, acrylic polymer emulsions, for example, JONCRYL 74™, 89™, 130™, 537™ and 538™ available from SC Johnson Wax; and chlorinated polypropylenes and polyethylenes available from Allied Chemical, Petrolite Corp. and SC Johnson. Mixtures and combinations of the foregoing waxes also may be used in embodiments.

In embodiments, a toner is a low melt toner. When a wax is included in a low wax toner, the wax(s) may have a Tₘ of about 100° or less, about 97.5° or less, about 95° or less or lower.

c. Surface Additive

In embodiments, the toner particles may be mixed with one or more additives, such as, silicon dioxide or silica (SiO₂), titania or titanium dioxide (TiO₂) and/or cerium oxide. Silica may be a first silica and a second silica. The first silica may have an average primary particle size, measured in diameter, in the range of, for example, from about 5 nm to about 50 nm, from about 5 nm to about 25 nm, from about 20 nm to about 40 nm. The second silica may have an average primary particle size, measured in diameter, in the range of, for example, from about 100 nm to about 200 nm, from about 100 nm to about 150 nm, from about 125 nm to about 145 nm. The second silica may have a larger average size (diameter) than the first silica. The titania may have an average primary particle size in the range of from about 5 nm to about 50 nm, from about 5 nm to about 20 nm, from about 10 nm to about 50 nm. The cerium oxide may have an average primary particle size in the range of from about 5 nm to about 50 nm, from about 5 nm to about 20 nm, from about 10 nm to about 50 nm.

Zinc stearate may be used as an external additive. Calcium stearate and magnesium stearate may provide similar functions. Zinc stearate may have an average primary particle size of, for example, from about 500 nm to about 700 nm, from about 500 nm to about 600 nm, from about 550 nm to about 650 nm.

B. Toner Particle Preparation

1. Method

a. Particle Formation

An emulsification/aggregation process, a resin may be dissolved in a solvent, and may be mixed into an emulsion medium, for example, water, such as, deionized water (DIW).

Optionally, a surfactant may be added to the aqueous emulsion medium, for example, to afford additional stabilization to the resin or to enhance emulsification of the resin. Suitable surfactants include anionic, cationic and nonionic surfactants as taught herein.

In embodiments relating to an exemplified EA process, following emulsification, toner compositions may be prepared by aggregating a mixture of a resin, an optional pigment, an optional wax and any other desired additives in an emulsion, optionally, with surfactants as described above, and then optionally coalescing the aggregate mixture. The pH of the resulting mixture may be adjusted with an acid, such as, for example, acetic acid, nitric acid or the like. In embodiments, the pH of the mixture may be adjusted to from about 2 to about 4.5.

The solids content on the emulsion can be at least about 10%, at least about 15%, at least about 20%, or more. For example, the solids loading can be from about 10% to about 15%, from about 15% to about 20%.

Additionally, in embodiments, the mixture may be homogenized. If the mixture is homogenized, mixing may be at from about 600 to about 4,000 rpm. Homogenization may be by any suitable means, including, for example, an IKA ULTRA TURRAX T50 probe homogenizer.

b. Aggregation

Following preparation of the above mixture, often, it is desirable to form larger particles or aggregates, often sized in micrometers, of the smaller particles from the initial polymerization reaction, often sized in nanometers. An aggregating factor (also known as a coagulant or flocculant) may be added to the mixture. Suitable aggregating factors include, for example, aqueous solutions of a divalent cation, a multivalent cation or a compound comprising same.

The aggregating factor, as provided above, may be, for example, a polyaluminum halide, such as, polyaluminum chloride (PAC) or the corresponding bromide, fluoride or iodide; a polyaluminum silicate, such as, polyaluminum sulfosilicate (PASS); or a water soluble metal salt, including, aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate or combinations thereof.

In embodiments, the aggregating factor may be added to the mixture at a temperature that is below the glass transition temperature (T_{g}) of the resin or of a polymer.

The aggregating factor may be added to the mixture components to form a toner in an amount of, for example, from about 0.1 part per hundred (pph) to about 1 pph, from about 0.25 pph to about 0.75 pph.

To control aggregation of the particles, the aggregating factor may be metered into the mixture over time. For example, the factor may be added incrementally into the mixture over a period of from about 5 to about 240 minutes, from about 30 to about 200 minutes.

Addition of the aggregating factor also may be done while the mixture is maintained under stirred conditions, from about 50 rpm to about 600 rpm, from about 100 rpm to about 400 rpm; and at a temperature at least about 50° C., at least about 51° C., at least about 52° C., at least about 53° C. and higher, up to about 60° C.

The particles are permitted to aggregate until a predetermined size is obtained. Particle size may be monitored during the growth process. For example, samples may be taken during the growth process and analyzed, for example, with a COULTER COUNTER, for average particle size. The aggregation thus may proceed by maintaining the mixture, for example, at least about 50° C., at least about 51° C., or higher, up to about 60° C., and holding the mixture at that temperature for from about 0.5 hours to about 6 hours, from about hour 1 to about 5 hours, while maintaining stirring, to provide the desired aggregated particles. Once the predetermined desired particle size is attained, the growth process is halted by using a chelating agent alone.

A sequestering agent or chelating agent is introduced when aggregation is complete to adjust pH to freeze toner particle growth and to sequester or to extract a metal complexing ion, such as, aluminum, from the aggregation process. Thus, the sequestering, chelating or complexing agent used after aggregation is complete may comprise an organic complexing component, such as, ethylenediaminetetraacetic acid (EDTA), gluconal, hydroxyl-2,2′iminodisuccinic acid (HIDS), dicarboxylmethyl glutamic acid (GLDA), methyl glycidyl diacetic acid (MGDA), hydroxydiethyliminodiacetic acid (HIDA), potassium citrate, sodium citrate, nitrotriacetate salt, humic acid, glutamic acid, gluconic acid, N,N diacetic acid, fulvic acid, hydroxyethylethylene diaminetriacetic acid (HEDTA). (hydroxyethylidene diphosphonio acid (HEDP), humic acid, pentaacetic acid, tetraacetic acid, methylglycine diacetic acid, ethylenediamine disuccinic acid, salts of oxycarboxylic acids, such as, tartaric acid, imino diacid (IDA), nitrilotriacetic acid (NTA), salts of aminopolycarboxylic acids; salts of EDTA, such as, alkali metal salts of EDTA, tartaric acid, oxalic acid, polyacrylates, sugar acrylates, citric acid, polyaspartic acid, diethylenetriamine pentaacetate, 3-hydroxy-4-pyridinone, dopamine, eucalyptus, iminodisuccinic acid, ethylenediaminedisuccinate, polysaccharide, sodium ethylenedinitrilotetraacetate, thiamine pyrophosphate, farnesyl pyrophosphate, 2-aminoethylpyrophosphate, hydroxyl ethylidene-1,1-diphosphonic acid, aminotrimethylenephosphonic acid, diethylene triaminepentamethylene phosphonic acid, ethylenediamine tetramethylene phosphonic acid, salts of such compounds, and mixtures thereof, see, for example, U.S. Pat. Nos. 8,501,380; 8,431,302; 8,158,319 and 7,618,761, each herein incorporated by reference in entirety.

Once the desired final size of the nascent toner particles or aggregates is achieved, the pH of the mixture is adjusted with chelating agent alone to a value of from about 6 to about 10, from about 7 to about 9. The adjustment of pH is used, in part, to freeze, that is, to stop, toner particle growth.

The aggregated particles may be less than about 7 μm in size, from about 2 μm to about 7 μm, from about 3 μm to about 6 μm.

c. Shells

In embodiments, after aggregation, generally prior to coalescence, a resin coating may be applied to the aggregated particles to form a shell thereover. Any resin described herein or as known in the art may be used as the shell. In embodiments, a polyester amorphous resin latex as described herein may be included in the shell. In embodiments, a polyester amorphous resin latex described herein may be combined with a different resin, and then added to the particles as a resin coating to form a shell. In embodiments, a low molecular weight amorphous polyester resin may be used to form a shell over the particles or aggregates.

A shell resin may be applied to the aggregated particles by any method within the purview of those skilled in the art. In embodiments, the resins used to form the shell may be in an emulsion, optionally including any surfactant described herein. The emulsion possessing the resins may be combined with the aggregated particles so that the shell forms over the aggregated particles.

Formation of the shell over the aggregated particles may occur while heating to a temperature from 50° C. or greater, from 51° C. or greater, from about 52° C. or greater, from about 53° C. or greater, or more, up to about 60° C. Formation of the shell may take place for a period of time from about 5 minutes to about 10 hours, from about 10 minutes to about 5 hours.

The shell may be present in an amount from about 1% by weight to about 80% by weight of the toner components, from about 10% by weight to about 40% by weight of the toner components, from about 20% by weight to about 35% by weight of the toner components.

d. Coalescence

Following aggregation to a desired particle size and application of any optional shell, the particles then may be coalesced to a desired final shape, such as, a circular shape, for example, to correct for irregularities in shape and size, the coalescence being achieved by, for example, heating the mixture from the aggregation temperature from about 75° or greater, from about 80° C. or greater, from about 85° C. or greater, from about 90° C. or greater, or more which may be at or above the T_{g} of the resins or below the melting point of the resin(s) used to form the toner particles, and/or reducing the stirring, for example, to from about 1000 rpm to about 100 rpm, from about 800 rpm to about 200 rpm. The pH of the mixture is maintained at the aggregation freeze pH by introducing additional chelating agent as needed. Coalescence may be conducted over a period from about 0.01 to about 9 hours, from about 0.1 to about 4 hours, see, for example, U.S. Pat. No. 7,736,831.

Optionally, a coalescing agent may be used. Examples of suitable coalescence agents include, but are not limited to, benzoic acid alkyl esters, ester alcohols, glycol/ether-type solvents, long chain aliphatic alcohols, aromatic alcohols, mixtures thereof and the like.

In embodiments, the coalescence agent (or coalescing agent or coalescence aid agent) evaporates during later stages of the emulsion/aggregation process, such as, during a second heating step, that is, generally above the T_{g} of the resin or a polymer. The final toner particles are thus, free of, or essentially or substantially free of any remaining coalescence agent. To the extent that any remaining coalescence agent may be present in a final toner particle, the amount of remaining coalescence agent is such that presence thereof does not affect any properties or the performance of the toner or developer.

The coalescence agent may be added prior to the coalescence or fusing step in any desired or suitable amount. For example, the coalescence agent may be added in an amount of from about 0.01 to about 10% by weight, based on the solids content in the reaction medium, from about 0.05, from about 0.1%, to about 0.5 or to about 3.0% by weight, based on the solids content in the reaction medium. Of course, amounts outside those ranges may be used, as desired.

In embodiments, the coalescence agent may be added at any time between aggregation and coalescence, although in some embodiments it may be desirable to add the coalescence agent after aggregation is, “frozen,” or completed with the chelating agent.

Coalescence may proceed and be accomplished over a period of from about 0.1 to about 9 hours, from about 0.5 to about 4 hours.

After coalescence, the mixture may be cooled to room temperature (RT), such as, from about 20° C. to about 25° C. The cooling may be rapid or slow, as desired. A suitable cooling method may include introducing cold water in a jacket around the reactor. After cooling, the toner particles optionally may be washed with water and then dried. Drying may be accomplished by any suitable method for drying including, for example, freeze drying.

e. Optional Additives

In embodiments, the toner particles also may contain other optional additives.

### i. Charge Additives

The toner may include any known charge additives in amounts of from about 0.1 to about 10 weight %, from about 0.5 to about 7 weight % of the toner. Examples of such charge additives include alkyl pyridinium halides, bisulfates, the charge control additives of U.S. Pat. Nos. 3,944,493; 4,007,293; 4,079,014; 4,394,430; and 4,560,635, the disclosures of each of which are hereby incorporated by reference in entirety, negative charge enhancing additives, such as, aluminum complexes, and the like.

Charge enhancing molecules may be used to impart either a positive or a negative charge on a toner particle. Examples include quaternary ammonium compounds, see, for example, U.S. Pat. No. 4,298,672, organic sulfate and sulfonate compounds, see for example, U.S. Pat. No. 4,338,390, cetyl pyridinium tetrafluoroborates, distearyl dimethyl ammonium methyl sulfate, aluminum salts and so on.

Such enhancing molecules may be present in an amount of from about 0.1 to about 10%, from about 1 to about 3% by weight.

### ii. Surface Modifications

Surface additives may be added to the toner compositions of the present disclosure, for example, after washing or drying. Examples of such surface additives include, for example, one or more of a metal salt, a metal salt of a fatty acid, a colloidal silica, a metal oxide, such as, TiO₂ (for example, for improved RH stability, tribo control and improved development and transfer stability), an aluminum oxide, a cerium oxide, a strontium titanate, SiO₂, mixtures thereof and the like. Examples of such additives include those disclosed in U.S. Pat. Nos. 3,590,000; 3,720,617; 3,655,374; and 3,983,045, the disclosure of each of which hereby is incorporated by reference in entirety.

Surface additives may be used in an amount of from about 0.1 to about 10 wt %, from about 0.5 to about 7 wt % of the toner.

Other surface additives include lubricants, such as, a metal salt of a fatty acid (e.g., zinc or calcium stearate) or long chain alcohols, such as, UNILIN 700 available from Baker Petrolite and AEROSIL R972® available from Degussa. The coated silicas of U.S. Pat. Nos. 6,190,815 and 6,004,714, the disclosure of each of which hereby is incorporated by reference in entirety, also may be present. The additive may be present in an amount of from about 0.05 to about 5%, from about 0.1 to about 2% of the toner, which additives may be added during the aggregation or blended into the formed toner product.

The gloss of a toner may be influenced by the amount of retained metal ion, such as, Al³⁺, in a particle. The amount of retained metal ion may be adjusted further by the addition of a chelating agent, such as, EDTA. In embodiments, the amount of retained catalyst, for example, Al³⁺, in toner particles of the present disclosure may be about 100 ppm or less, about 80 ppm or less, about 60 ppm or less, or less. The gloss level of a toner of the instant disclosure may have a gloss, as measured by Gardner gloss units (gu), of from about 10 gu to about 70 gu, from about 15 gu to about 65 gu, from about 20 gu to about 60 gu.

Use of the chelating agent reduces retained metal ion content, thereby increasing gloss of the final image.

Hence, a particle may contain at the surface one or more silicas, one or more metal oxides, such as, a titanium oxide and a cerium oxide, a lubricant, such as, a zinc stearate and so on. In embodiments, a particle surface may comprise two silicas, two metal oxides, such as, titanium oxide and cerium oxide, and a lubricant, such as, a zinc stearate. All of those surface components may comprise about 5% by weight of a toner particle weight. There may also be blended with the toner compositions, external additive particles including flow aid additives, which additives may be present on the surface of the toner particles. Examples of these additives include metal oxides like titanium oxide, tin oxide, mixtures thereof, and the like; colloidal silicas, such as AEROSIL®, metal salts and metal salts of fatty acids, including zinc stearate, aluminum oxides, cerium oxides and mixtures thereof. Each of the external additives may be present in embodiments in amounts of from about 0.1 to about 5 wt %, from about 0.1 to about 1 wt %, of the toner. Several of the aforementioned additives are illustrated in U.S. Pat. Nos. 3,590,000, 3,800,588, and 6,214,507, the disclosure of each of which is incorporated herein by reference.

Toners may possess suitable charge characteristics when exposed to extreme relative humidity (RH) conditions. The low humidity zone (C zone) may be about 10° C. and 15% RH, while the high humidity zone (A zone) may be about 28° C. and 85% RH.

Toners of the instant disclosure also may possess a parent toner charge per mass ratio (q/m) of from about −5 μC/g to about −90 μC/g, and a final toner charge after surface additive blending of from about −15 μC/g to about −80 μC/g.

Other desirable characteristics of a toner include storage stability, particle size integrity, high rate of fusing to the substrate or receiving member, sufficient release of the image from the photoreceptor, nondocument offset, use of smaller-sized particles and so on, and such characteristics may be obtained by including suitable reagents, suitable additives or both, and/or preparing the toner with particular protocols.

The characteristics of the toner particles may be determined by any suitable technique and apparatus. Volume average particle diameter and geometric standard deviation may be measured using an instrument, such as, a Beckman Coulter MULTISIZER 3, operated in accordance with the instructions of the manufacturer.

The dry toner particles, exclusive of external surface additives, may have: (1) a volume average diameter (also referred to as “volume average particle diameter”) of from about 2.5 to about 20 μm, from about 2.75 to about 10 μm, from about 3 to about 7.5 μm; (2) a number average geometric standard deviation (GSDn) and/or volume average geometric standard deviation (GSDv) of from about 1.18 to about 1.30, from about 1.21 to about 1.24; and (3) circularity of from about 0.9 to about 1.0 (measured with, for example, a Sysmex FPIA 2100 analyzer), from about 0.95 to about 0.985, from about 0.96 to about 0.98.

### III. Developers

A. Composition

The toner particles thus formed may be formulated into a developer composition. For example, the toner particles may be mixed with carrier particles to achieve a two component developer composition. The toner concentration in the developer may be from about 1% to about 25% by weight of the total weight of the developer, from about 2% to about 15% by weight of the total weight of the developer, with the remainder of the developer composition being the carrier. However, different toner and carrier percentages may be used to achieve a developer composition with desired characteristics.

1. Carrier

Examples of carrier particles for mixing with the toner particles include those particles that are capable of triboelectrically obtaining a charge of polarity opposite to that of the toner particles. Illustrative examples of suitable carrier particles include granular zircon, granular silicon, glass, steel, nickel, ferrites, iron ferrites, silicon dioxide, one or more polymers and the like. Other carriers include those disclosed in U.S. Pat. Nos. 3,847,604; 4,937,166; and 4,935,326.

In embodiments, the carrier particles may include a core with a coating thereover, which may be formed from a polymer or a mixture of polymers that are not in close proximity thereto in the triboelectric series, such as, those as taught herein or as known in the art. The coating may include fluoropolymers, such as, polyvinylidene fluorides, terpolymers of styrene, methyl methacrylates, silanes, such as triethoxy silanes, tetrafluoroethylenes, other known coatings and the like. For example, coatings containing polyvinylidenefluoride, available, for example, as KYNAR 301™, and/or polymethylmethacrylate (PMMA), for example, having a weight average molecular weight of about 300,000 to about 350,000, such as, commercially available from Soken, may be used. In embodiments, PMMA and polyvinylidenefluoride may be mixed in proportions of from about 30 to about 70 wt % to about 70 to about 30 wt %, from about 40 to about 60 wt % to about 60 to about 40 wt %. The coating may have a coating weight of, for example, from about 0.1 to about 5% by weight of the carrier, from about 0.5 to about 2% by weight of the carrier.

Various effective suitable means may be used to apply the polymer to the surface of the carrier core, for example, cascade roll mixing, tumbling, milling, shaking, electrostatic powder cloud spraying, fluidized bed mixing, electrostatic disc processing, electrostatic curtain processing, combinations thereof and the like. The mixture of carrier core particles and polymer then may be heated to enable the polymer to melt and to fuse to the carrier core. The coated carrier particles then may be cooled and thereafter classified to a desired particle size.

The carrier particles may be prepared by mixing the carrier core with polymer in an amount from about 0.05 to about 10% by weight, from about 0.01 to about 3% by weight, based on the weight of the coated carrier particle, until adherence thereof to the carrier core is obtained, for example, by mechanical impaction and/or electrostatic attraction.

In embodiments, suitable carriers may include a steel core, for example, of from about 25 to about 100 μm in size, from about 50 to about 75 μm in size, coated with about 0.5% to about 10% by weight, from about 0.7% to about 5% by weight of a polymer mixture including, for example, methylacrylate and carbon black, using the process described, for example, in U.S. Pat. Nos. 5,236,629 and 5,330,874.

### IV. Devices Comprising a Toner Particle

Toners and developers may be combined with a number of devices ranging from enclosures or vessels, such as, a vial, a bottle, a flexible container, such as a bag or a package, and so on, to devices that serve more than a storage function.

A. Imaging Device Components

The toner compositions and developers of interest may be incorporated into devices dedicated, for example, to delivering same for a purpose, such as, forming an image. Hence, particularized toner delivery devices are known, see, for example, U.S. Pat. No. 7,822,370, and may contain a toner preparation or developer of interest. Such devices include cartridges, tanks, reservoirs and the like, and may be replaceable, disposable or reusable. Such a device may comprise a storage portion; a dispensing or delivery portion; and so on; along with various ports or openings to enable toner or developer addition to and removal from the device; an optional portion for monitoring amount of toner or developer in the device; formed or shaped portions to enable siting and seating of the device in, for example, an imaging device; and so on.

B. Toner or Developer Delivery Device

A toner or developer of interest may be included in a device dedicated to delivery thereof, for example, for recharging or refilling toner or developer in an imaging device component, such as, a cartridge, in need of toner or developer, see, for example, U.S. Pat. No. 7,817,944, wherein the imaging device component may be replaceable or reusable.

### V. Imaging Devices

The toners or developers may be used for electrostatographic or electrophotographic processes, including those disclosed in U.S. Pat. No. 4,295,990, the disclosure of which hereby is incorporated by reference in entirety. In embodiments, any known type of image development system may be used in an image developing device, including, for example, magnetic brush development, jumping single component development, hybrid scavengeless development (HSD) and the like. Those and similar development systems are within the purview of those skilled in the art.

Color printers commonly use four housings carrying different colors to generate full color images based on black plus the standard printing colors, cyan, magenta and yellow. However, in embodiments, additional housings may be desirable, including image generating devices possessing five housings, six housings or more, thereby providing the ability to carry additional toner colors to print an extended range of colors (extended gamut).

The toners of interest comprise higher levels of chelating agent, such as, chelating agent, can have higher pigment loading and can comprise lower levels of metal ion, thereby increasing gloss. Such hyperpigmented toners with lower TMA nevertheless provide suitable images on substrates, such as, paper.

The following Examples illustrate embodiments of the instant disclosure. The Examples are intended to be illustrative only and are not intended to limit the scope of the present disclosure. Parts and percentages are by weight unless otherwise indicated.

### EXAMPLES

### Example 1 Comparative EA-HY Yellow (Y) Toner Control, Standard Process

A yellow toner, having about 9.425% yellow pigment with particles of about 5.45 μm in size was prepared as follows. In a 20 gallon reactor, the following components were combined: about 5.3 kg of an amorphous polyester resin in an emulsion (polyester emulsion A), having an average molecular weight (Mw) of about 86,000, a number average molecular weight (Mn) of about 5,600, an onset glass transition temperature (Tg onset) of about 56° C., and about 35% solids; about 7.9 kg of an amorphous polyester resin in an emulsion (polyester emulsion B) having an Mw of about 19,400, an Mn of about 5,000, a Tg onset of about 60° C., and about 35% solids; about 2.2 kg of a crystalline polyester resin in an emulsion, having an Mw of about 23,300, an Mn of about 10,500, a melting temperature (Tm) of about 71° C. and about 35.4% solids; about 5.5 kg of yellow pigment, Mexico Yellow (about 20.4% solids); about 3.2 kg of polyethylene wax in an emulsion, having a Tm of about 90° C., and about 30% solids; about 1.7 kg of 0.3 molar HNO₃; and about 25.6 kg of deionized water.

Thereafter, about 2.464 kg of a flocculent mixture containing about 197 grams aluminum sulfate and about 2.27 kg of deionized water (DIW) were added through an in-line homogenizer over a period of about 6 minutes. As the flocculent mixture was added, the homogenizer speed was increased to about 350 rpm and homogenized for an additional 30 minutes. Thereafter, the mixture was stirred at about 360 rpm and heated at a 1° C. per minute temperature increase to a temperature of about 50° C. and held there for a period of from about 1.5 hours to about 2 hours resulting in particles having a volume average particle diameter of about 4.6-4.8 μm as measured with a COULTER COUNTER.

An additional 4.4 kg of polyester emulsion A and 6.6 kg of polyester emulsion B were added to the reactor mixture and allowed to aggregate for an additional period of about 40 minutes, resulting in particles having a volume average particle diameter of about 5.8 μm. The pH of the reactor mixture was adjusted to about 4.5 with a 1 molar sodium hydroxide solution, followed by the addition of about 423 grams of VERSENE 100 [an ethylene diamine tetraacetic acid (EDTA) chelating agent solution]. The pH of the reactor mixture then was adjusted to about 7.8 with a 1 molar sodium hydroxide solution, and the stirring reduced to about 200 rpm. The reactor mixture the was heated at a temperature increase of about 1° C. per minute to a temperature of about 85° C. while maintaining the pH to 7.8 using 1 molar sodium hydroxide solution.

The pH of the mixture was then adjusted to about 6.4 with a sodium acetate buffer solution. The reactor mixture then was stirred gently at about 85° C. for about 1.5 hours to coalesce and to spheroidize the particles. The mixer then is discharged and the mixture is quenched through a heat exchanger using domestic cold water (10-12° C.) while sifting using a 15 μm screen. A hot glycol/water heating system then was applied to full cooling and shut down when the slurry reached below 40° C. The toner of had a volume average particle diameter of about 5.6 μm, a geometric size distribution (GSD) of about 1.20 and a circularity of about 0.954. The particles were washed 3 times with DIW at RT and then dried using the Aljet dryer.

### Example 2 Experimental 20 Gallon Y Toner

A yellow toner, having about 9.425% yellow pigment, with particles of about 5.45 μm in size, was prepared as per the process described above in Comparative Example 1, with the following modifications. About 5.3 kg of polyester emulsion A was combined with about 7.9 kg of polyester emulsion B, about 2.2 kg of the crystalline polyester emulsion from Example 1, about 5.5 kg Mexico Yellow pigment, about 3.2 kg of the polyethylene wax emulsion, about 1.7 kg of 0.3 molar HNO₃, and about 25.6 kg of DIW. As in Example 1, the mixture was homogenized. The same flocculent mixture of Example 1 containing about 197 g aluminum sulfate and about 2.27 kg of DIW was added through the in-line homogenizer over a period of about 6 minutes. As the flocculent mixture was added, the homogenizer speed was increased to about 350 rpm and homogenized for an additional 30 minutes. Thereafter, the mixture was stirred at about 360 rpm and heated at a 1° C. per minute temperature increase to a temperature of about 50° C. and held there for a period of from about 1.5 hours to about 2 hours resulting in particles having a volume average particle diameter of about 4.6-4.8 μm as measured with a COULTER COUNTER.

An additional 4.4 kg of polyester emulsion A and 6.6 kg of polyester emulsion B were added to the reactor mixture and allowed to aggregate for an additional period of about 40 minutes, resulting in particles having a volume average particle diameter of about 5.8 μm. The pH of the reactor mixture was adjusted to about 7.8 using VERSENE 100 and the stirring reduced to about 200 rpm. The reactor mixture then was heated at a temperature increase of about 1° C. per minute to a temperature of about 85° C. while maintaining H to 7.8 using Versene 100.

The pH of the mixture then was adjusted to about 7.3 with a sodium acetate buffer solution. The reactor mixture was stirred gently at about 85° C. for about 1.5 hours to coalesce and to spheroidize the particles. The mixer then was discharged and quenched through a heat exchanger using domestic cold water (10-12° C.) and maintained at a slurry temperature to 40° C. and below while sifting using a 15 μm screen. The hot glycol/water heating system was then applied to full cooling and shut down when the slurry temperature reached below 40° C. The toner had a volume average particle diameter of about 5.6 μm, a geometric size distribution (GSD) of about 1.20 and a circularity of about 0.959. The particles were washed 3 times with DIW at RT and then dried using the Aljet dryer.

### Example 3

Similar black (K), magenta (M) and cyan (C) control and experimental toners were constructed as provided in Examples 1 and 2 for Y toners.

### Example 4

### Particle Properties of Control and Experimental Y Toners

The particle properties of toner prepared by the standard control method are shown in Table 1. The particle properties of the toner prepared by the inventive method are shown in Table 2 with meaning minutes of aggregation time.

TABLE 1
Control Toners

| ID | K1 | K2 | M | C1 |
|---|---|---|---|---|
| Agg temp | 47.5° C. | 50° C. | 50° C. | 48° C. |
| Pre-shell agg time (min) | 43 | 56 | 158 | 215 |
| Pre-shell temp | 47 | 50 | 49.5 | 49 |
| Post-shell agg time (min) | 140 | 50 | 71 | 170 |
| Dry D₅₀ᵥ | 5.37 | 5.44 | 5.48 | 5.20 |
| Final Coalesce pH | 6.4 | 6.8 | 5.8 | 7 |
| Versene (kg) | .423 | .423 | .423 | .423 |
| NaOH (kg) | 1.74 | 1.36 | 1.63 | 1.3 |
| Al (ppm) | 51.74 | 59.84 | 133 | 102 |
| Na (ppm) | 1647 | 1227 | 18778 | 1809 |

TABLE 2
Experimental Toners

| ID | K1 | K2 | K3 | M1 | M2 | C1 | C2 |
|---|---|---|---|---|---|---|---|
| Agg temp | 50° C. | 50° C. | 50° C. | 55° C. | 54.5° C. | 54.5° C. | 54.5° C. |
| Pre-shell agg time | 53′ | 56′ | 48′ | 158′ | 89′ | 74′ | 57′ |
| Pre-shell temp | 49.5 | 49.5 | 49.5 | 54 | 52 | 51.5 | 51.5 |
| Post-shell agg time | 60 | 50 | 60 | 20 | 40 | 25 | 40 |
| Dry D_{50 v} | 5.59 | 5.48 | 5.48 | 5.96 | 5.42 | 5.54 | 5.54 |
| Final Coalesce pH | 7 | 6.9 | 6.8 | 6.2 | 6.9 | 7.2 | 7.2 |
| Versene (kg) | 1.44 | 1.44 | 1.46 | 1.92 | 1.81 | 1.56 | 2.0 |
| NaOH (kg) | 0 | 0 | 0 | 0 | 0 | 0 | 0 |
| Al (ppm) | 65.6 | 60.2 | 71 | 111.7 | 98.8 | 98 | 94.4 |
| Na (ppm) | 1742 | 1734 | 1781 | 2073 | 3445 | 2673 | 3599 |

The K, M and C toners prepared by the experimental process show robust lower Al levels in all cases despite the higher aggregation and coalescence temperatures and shorter coalescence times at nominal 14% solids loading. The amount of EDTA used is increased with the experimental process from about 0.4 Kg Versene 100/11 Kg of dried toner for the controls to about 1.4 to 2.3 Kg/11 Kg of dried toner at 14% solids for the experimentals. At higher solids loading, the amount of EDTA used increases approximately proportionally. Versene 100 is 38 wt % of sodium EDTA. Thus, in terms of dry sodium EDTA about 0.152 kg of dry sodium EDTA/11 kg of dry toner is required for the control, about 0.5 to about 0.9 Kg dry sodium EDTA/11 Kg of dried experimental toner at 14% solids, or as much as 1.3 kg/15 Kg at 20% solids loading.

### Example 5

### Bench Charging and Fusing Evaluation

Bench charge was obtained for parent toner by weighing the toner at 6% TC with 30 g standard carrier at 30 gram scale. For the blended toner EA toner a 10-L Henschel blend was done with a known additive package comprising silicas, surface treated titanium and polytetrafluoroethylene in certain amounts. After conditioning samples a minimum of 48 hours for J-zone (at about 20° C. and 10% RH) and a minimum 24 hours for A-zone (at about 28° C./85% relative humidity), the developers were charged in a Turbula mixer for 10 mins for parent developer and 10 minutes and 60 minutes for the blended toner with additives. The toner charge was measured in the form of q/d, the charge to diameter ratio. The q/d was measured using a charge spectrograph visually as the midpoint of the toner charge distribution. The charge was reported in millimeters of displacement from the zero line. The final mm displacement can be converted to femtocoulombs/micron (fC/μm) by multiplying by 0.092.

The toner charge per mass ratio (q/m) was also determined by the total blow-off charge method, measuring the charge on a faraday cage containing the developer after removing the toner by blow-off in a stream of air. The total charge collected in the cage is divided by the mass of toner removed by the blow-off, by weighing the cage before and after blow-off to provide the q/m ratio.

Dielectric loss of the toners was obtained by first creating a toner pellet. The parent toner sample was placed in a spring-loaded 2-in diameter mold and pressed by a precision-ground plunger at about 2000 psi for 2 minutes. While maintaining contact with the plunger (which acts as one electrode), the pellet was then forced out of the mold onto a spring-loaded support, which keeps the pellet under pressure and also acts as the counter electrode. Using an HP4263B LCR Meter via shielded 1 meter BNC cables, dielectric and dielectric loss were determined by measuring capacitance (Cp) and loss factor (D) at 100 kHz frequency and 1 VAC.

Overall, the charging, dielectric loss and flow performance of all experimental toners are comparable to that of the corresponding color control toner. Overall, blocking is better for the inventive toners as compared to the control toners of the same color.

Unfused print images of TMA of 1.00 mg/cm² were made on CXS paper (Color Xpressions Select, 90 gsm, uncoated) and used for gloss, crease, cold offset and hot offset measurements. Samples were fused with an off-line fusing fixture, consisting of a production fuser that was fitted with an external motor and temperature control along with paper feeders. Process speed was 220 mm/s and the fuser roll temperature was varied from cold offset to hot offset or up to 210° C. for gloss and crease measurements on the samples.

Fusing was compared to commercial cyan control toner. All the toners made by the inventive process for all colors show very similar behavior as the control cyan. No issue with fusing performance was noted for any of the experimental toners.

### Example 6

### Machine Testing

Five thousand prints were made in a Xerox 7556 printer at both 30% print area coverage and at 2% print area coverage including a sustained 2% area coverage for 1000 prints in each of A-zone and J-zone under full machine control. For each zone, the average, minimum and maximum OD reflection density (ODr) were calculated based on prints on CSX uncoated paper, as well as the average Al charge and the aging delta in At, which is the increase in charge during the sustained 2% area coverage. In addition, a series of prints were obtained in B-zone to measure TMA, ODr and gloss relationships on two papers, the uncoated CSX and the coated DCEG paper.

Results revealed that all ODr values. At charge values and At charge increase on aging values were similar for the experimental toners and control production toners, which were within the spec ranges. There were no obvious differences in image quality—all the prints were within specification.

TABLE 3

| | TMA | TMA | TMA | Gloss | Gloss | Gloss |
|---|---|---|---|---|---|---|
| Paper | Uncoated | Uncoated | Coated | Un- | Uncoated | Coated |
| | | | | coated | | |
| ODr | 1.45 | 1.65 | 1.65 | 1.45 | 1.65 | 1.65 |
| Control | 0.40 | 0.53 | 0.42 | 32 | 38 | 59 |
| Cyan | | | | | | |
| Experi- | 0.35 | 0.46 | 0.36 | 28 | 33 | 52 |
| mental | | | | | | |
| Cyan | | | | | | |

TABLE 4

| | TMA | TMA | TMA | Gloss | Gloss | Gloss |
|---|---|---|---|---|---|---|
| Paper | Uncoated | Un- | Coated | Un- | Un- | Coated |
| | | coated | | coated | coated | |
| ODr | 1.45 | 1.65 | 1.65 | 1.45 | 1.65 | 1.65 |
| Control | 0.44 | 0.5 | 0.44 | 34 | 36 | 54 |
| Magenta | | | | | | |
| Experimental | 0.38 | 0.44 | 0.38 | 30 | 32 | 48 |
| Magenta | | | | | | |

Tables 3 and 4 show that due to the additional pigment loading in the hyperpigmented toners at the same ODr, the TMA is significantly lower at the two different ODr values. That translates to less toner to obtain the same image density on the print. Results for two different ODr values are shown. Gloss for the experimental toners was similar to that of the control toners are both types of papers. Any difference in gloss values is not visually noticeable. Gloss is sensitive to ODr.

It will be appreciated that various of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color or material.

All references cited herein are herein incorporated by reference in entirety.

We claim:

1. A method for making a high gloss toner particle in the absence of base in the aggregation freezing step comprising the steps of:
a) mixing reagents comprising one or more amorphous resins, an optional crystalline resin, an optional wax, an optional colorant and an optional gel latex to form an emulsion comprising a resin particle;
b) adding a flocculant and aggregating said resin particle to form a nascent toner particle;
c) optionally adding one or more resins to form a shell on said nascent toner particles to yield a core-shell particle;
d) freezing particle growth with a chelating agent to form an aggregated toner particle;
e) coalescing said aggregated toner particle to form said high gloss toner particle; and
f) collecting said high gloss toner particle.

2. The method of claim 1, wherein said chelating agent comprises ethylene diamine tetraacetic acid.

3. The method of claim 1, wherein maximum temperature in the aggregating step is about 50° C. or greater.

4. The method of claim 1 wherein maximum temperature in the aggregating step is from about 50° to about 55° C.

5. The method of claim 1 wherein solids loading is between about 10% to about 15%.

6. The method of claim 1 wherein solids loading is between about 15% to about 20%.

7. The method of claim 1, where said chelating agent is added in an amount to raise pH of said emulsion from about 6 to about 10.

8. The method of claim 1, where said chelating agent is added in an amount to raise pH of said emulsion from about 7 to about 9.

9. The method of claim 1, wherein said reagents comprise a crystalline resin.

10. The method of claim 1, wherein said reagents comprise at least two amorphous resins.

11. The method of claim 1, wherein said reagents comprise at least a high molecular weight amorphous resin and at least a low molecular weight amorphous resin.

12. The method of claim 1, wherein said reagents comprise a colorant in an amount at least about 7.5% by weight.

13. The method of claim 1, wherein said flocculant comprises aluminum.

14. The method of claim 13, wherein said toner particle comprises aluminum of about 100 ppm or less.

15. The method of claim 13, wherein said toner particle comprises aluminum of about 80 ppm or less.

16. The method of claim 1, wherein said reagents comprise a wax with a Tₘ of less than about 100° C.

17. The method of claim 1, which said aggregated toner particle is less than about 7 μm in size.

18. The method of claim 1, wherein coalescing is at a temperature of about 75° C. or higher.

19. The method of claim 1, wherein when said high gloss toner particles are fused to a substrate comprising an image comprising a toner mass area of 0.55 g/m² or less, said image comprises a gloss from about 10 gu to about 70 gu.

20. The method of claim 19, wherein said image comprises a gloss from about 15 gu to about 65 gu.
